(19) United States
(12) Patent Application Publication
(10) Pub. No.: US 2005/0166962 A1
(43) Pub. Date: Aug. 4, 2005

(54) Pressure storage vessel with separation apparatus and method of using the same

(76) Inventors: Gerald D. Neff, Edmond, OK (US); Mitchell Mark Orr, Acapulco (MX)

Correspondence Address: Martin G. Ozinga;Phillips McFall McCaffrey McVay & Murrah, P.C., One Leadership Square, 12th Floor, 211 N. Robinson Ave., Oklahoma City, OK, 73102, US

(21) Appl. No.: 11/045,448

(22) Filed: Jan. 27, 2005

Related U.S. Application Data
(60) Provisional application No. 60/541,787, filed on Feb. 4, 2004.

(51) Int. Cl. F16T 1/00

(52) U.S. Cl. 137/172

(57) ABSTRACT

The present invention essentially comprises a vessel built to maintain accumulated pressure generally having a separator means for separating the elements from the production of a well. The vessel may be relatively mobile in nature, usable to a plurality of wells, and may further be constructed by converting existing equipment. In a preferred embodiment, a pressure tested vessel will hold all of the produced liquids from a well, passing the natural gas to a sales line as it is separated from the fluids, allowing water to sink to the bottom of the vessel for drainage into a water storage tank for proper disposal, allowing condensate to form for recovery with any produced oil. The condensate and oil are stored until the vessel is nearly full, and then sold in the same manner as crude oil.

### CROSS-REFERENCE TO RELATED APPLICATIONS

Priority is claimed from provisional patent application U.S. Ser. No. 60/541,787 filed on Feb. 4, 2004, and incorporated by reference herein.

### BACKGROUND OF THE INVENTION

1. Field of the Invention

In general, the present invention relates to an apparatus, system and method of preserving and storing all production elements from oil and gas wells. More particularly, the present invention provides a storage vessel that can hold and capture under pressure all elements produced from a well and provide a means for separating the elements, such as but not limited to natural gas, water, oil, and associated condensate, in a usable and environmentally friendly system.

2. Description of the Prior Art

In the oil and gas industry, a major concern facing the field is the ever growing and constant concern with environmental impact of oil and gas production coupled with the ever increasing need to maximize efficiency and recovery. Prior art methods that were perfectly acceptable just years ago are now politically and environmentally unfriendly as well as wasteful in hindsight. Whereas it was acceptable to allow by-products from well production to be released into the environment, it is not considered a viable economic or environmentally sound method to date.

Typically of wells in general, subterranean fluids and gas are moved from below ground to above ground wherein the subterranean fluids and gas may be separated for use. It is common for the subterranean fluid to have mixtures of oil and water intermixed with gas in greatly varying proportions depending on many factors of the geological formation, type of well and so forth. Depending on the well profile of amounts of water, gas and oil present in the production, different types of recovery systems are employed, but all share the need for a system to separate and store the varying amounts of elements produced.

It is common to allow oil recovered from wells to be stored in storage facilities or tanks that allow venting into the environment. Most known systems in oil and gas wells recover the oil from the well production and store it in tanks that are non-pressurized vessels with a venting system to the open air. It is understood that oil in liquid form continues to release gasses and that the grade of the oil is a direct correlation to its volatility and thereby, its release of gaseous elements. These tanks in the prior art are not designed to hold pressure and must have the ability to vent gasses that accumulate and pass from the stored oil to prevent the tank from rupturing, leaking, and so forth.

It is also well known to pass production from wells into separator units wherein the gas, water, and oil are essentially separated. The separator unit then generally sends the separated elements, such as water, gas, and oil, into respective containment systems for each element. The vertical or horizontal separator or production units were invented in the 1930's and have not been materially changed since that time. These prior art devices are satisfactory for wells that produce heavy crude oil and have little or no evaporative qualities, but do not adequately handle the gas condensate production existing in today's market.

The term condensate normally refers to the liquid that condenses from the natural gas and is physically separated in liquid form at the surface. The natural gas that leaves the subterranean reservoir is subjected to pressure reduction and to cooling, each of which causes condensation of the heavier and intermediate hydrocarbons. Condensates are actually crude oil in that they are the same material except that in the particular reservoir in which they are found they are associated with sufficient methane at high enough pressure to evaporate them into the gas phase until such time as the pressure is reduced.

Although the majority of gas is recovered and passed into a separate storage vessel or line designed to hold natural gas, the separated oil goes into storage tanks and, as discussed above, the gaseous elements continue to be released or evaporate from the accumulated oil even after the separation. These known systems obviously do provide for the recovery of the majority of gas from the well, but a percentage of potential energy is still lost through the venting in the oil storage.

Whereas some types of wells may primarily recover oil and others natural gas, it is common that wells that primarily produce natural gas will naturally need a system to remove accumulated subterranean fluids from the well to allow the gas to more easily flow and for overall well management. Plunger lift wells are well known in the art for natural gas production and the removal of subterranean fluids from the well.

It is also very common for plunger lift well systems to be used on mature and marginal wells where the cost of operating the well may be prohibitive considering the limited or marginally value of the recovered production. In these marginal type well operations, the fine line between cost of operation and profit makes all manners of recovery of hydrocarbons a potential make or break factor. There is an ever increasing need for making these marginal wells more profitable to lengthen their production lives as costs and value of oil increase globally.

Air pollution continues to gather global concern. Currently, operators of gas wells are allowing venting and evaporation of gas and condensate into the atmosphere every day, which is a continual major source of air pollution that should be abated. Further, land and creeks are being polluted by improper handling of oil and saltwater from wells. The land, creeks, lakes and air around oilfield locations can be protected by producing the wells into a closed pressure system which prevents the escape of pollutants especially into the air.

Still further, a common technique in the industry is to take the production from various wells and run the production lines to a centralized collection point. By means of example, a field of five wells may use a central collection point for separating, collection and so forth. This may be achieved by running the five individual production lines to one centralized location. This is common to reduce equipment needs at each of the individual well sites. A common drawback of doing such is that it does not allow for individual assessment of the production and/or production ratio from one specific well in the field. What is needed in the industry is an efficient, cost effective, and timely means to selectively monitor, test, and/or collect production from a specific well in a field that utilizes a common collection system or point.

It would therefore be desirable to have a mobile unit for collection, separation, and or production monitoring that may be easily transported from well to well without the need for permanently installation of equipment found in the prior art. Still further, it is desirable to provide a portable test means in general for well systems that use a common production collection system.

The above discussed limitations in the prior art is not exhaustive. Thus, there is a need for an apparatus, method and system to separate the varying components found during well production that maximizes recovery of all hydrocarbons and is environmentally friendly. The current invention provides an inexpensive, time saving, more reliable apparatus and method of near complete recovery of hydrocarbons from a well where the prior art fails.

### SUMMARY OF THE INVENTION

In view of the foregoing disadvantages inherent in the known types of well production storage and separation methods now present in the prior art, the present invention provides a new and improved storage vessel and separation apparatus, system and method of use which may also be removably positioned to oil and gas wells. As such, the general purpose of the present invention, which will be described subsequently in greater detail, is to provide a new and improved storage vessel and separator which may hold pressure to capture and retain all hydrocarbons produced from a well which has all the advantages of the prior art devices and none of the disadvantages.

To attain this, the present invention essentially comprises a vessel built to maintain accumulated pressure generally having a separator means for separating the elements from the production of a well. The vessel may be relatively mobile in nature, usable to a plurality of wells, and may further be constructed by converting existing equipment.

In a preferred embodiment, a pressure tested vessel will hold all of the produced liquids from a well, passing the natural gas to a sales line as it is separated from the fluids, allowing water to sink to the bottom of the vessel for drainage into a water storage tank for proper disposal, allowing condensate to form for recovery with any produced oil. The condensate and oil is stored until the vessel is nearly full, and then sold in the same manner as crude oil.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction 110 and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved storage vessel with a separator and method of using the same which may be easily and efficiently manufactured and marketed.

It is a further object of the present invention to provide a new and improved storage vessel with a separator and method which is of a durable and reliable construction and may be utilized with multiple wells.

An even further object of the present invention is to provide a new and improved storage vessel with a separator and method which is susceptible to a low cost of manufacture with regard to both materials and labor, and which accordingly is then susceptible to low prices of sale to the consuming industry, thereby making such tool economically available to those in the field.

Still another object of the present invention is to provide a new and improved storage vessel with a separator and method which provides all of the advantages of the prior art, while simultaneously overcoming some of the disadvantages normally associated therewith.

Another object of the present invention is to provide a new and improved storage vessel with a separator and method which maximizes condensate recovery and prevents the venting and or evaporation of usable hydrocarbons into the atmosphere.

Yet another object of the present invention is to provide a new and improved storage vessel with a separator and method that may be manufactured from existing equipment such as but not limited to tanks typically associated with large trucks used to carry gas and other materials under pressure on roadways.

An even further object of the present invention is to provide a new and improved storage vessel with a separator and method which improves and lengthens the productive lives of mature, marginal, and sometimes uneconomical wells. A preferred embodiment of the invention is especially useful when used in conjunction with a plunger lift system.

Still another object of the present invention is to provide a new and improved storage vessel with a separator and method which allows keeping volatile high gravity condensate under pressure to prevent escape of the aforementioned into the environment.

Yet still another object of the present invention is to provide a new and improved storage vessel with a separator and method which increases the BTU rating of gas and therefore the profitability of a well.

In another preferred embodiment, the invention may further provide a mobile system for utilization of monitoring, testing, collecting, and/or separating production from an individual well that may be part of a common collection production system from multiple wells in a field.

These, together with other objects of the invention, along with the various features of novelty which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE PICTORIAL ILLUSTRATIONS GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, and appendices wherein:

FIG. 1 is an illustration of a preferred embodiment of the invention generally depicting a pressure vessel and well operation or wellhead assembly for a plunger lift system.

FIG. 2 is an illustration of a preferred embodiment of the invention generally depicting a partial cross sectional side view.

FIG. 3 is an illustration of a preferred embodiment of the invention generally depicting a partial cross sectional side view.

FIG. 4 is an illustration of a preferred embodiment of the invention generally depicting a partial cross sectional side view.

FIG. 5 is an illustration of a preferred embodiment of the invention generally depicting a partial cross sectional side view.

FIG. 6 is an illustration of another preferred embodiment of the invention generally depicting a partial cross sectional side view in conjunction with a holding tank configuration.

FIG. 7 is an illustration of the preferred embodiment of the invention depicted in FIG. 6 generally depicting a partial cross sectional side view.

FIG. 8 is an illustration of the preferred embodiment of the invention depicted in FIG. 6 generally depicting a partial cross sectional side view.

FIG. 9 is an illustration of the preferred embodiment of the invention depicted in FIG. 6 generally depicting a partial cross sectional side view.

### DETAILED DESCRIPTION OF THE PREFERRED EMBODIMENTS

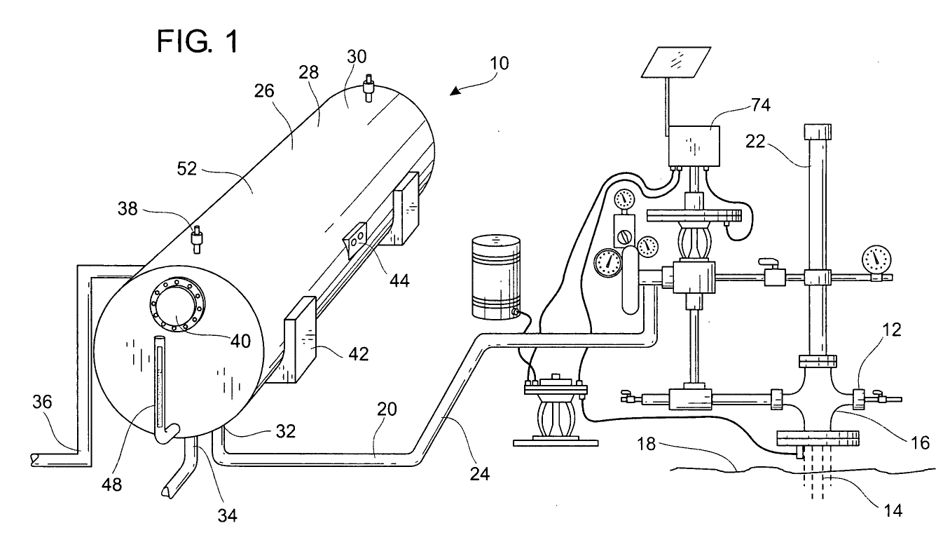

Referring to the illustrations, drawings, and pictures, and to FIG. 1 in particular, reference character 10 generally designates a new and improved storage vessel with a separator apparatus, system, and method of using same constructed in accordance with the present invention. Invention 10 is generally used in a well 12 utilizing tubing 14 for the retrieval of hydrocarbons below the surface. Well 12 tubing 14 generally comprises a top 16 at a surface 18 where product 20 such as hydrocarbons and or other subterranean fluids are produced by the well 12. Product 20 may be but is not limited to oil, crude oil, water, salt water, gas, natural gas, condensate and so forth. The term product 20 may be generalized to mean all items, materials, and things that flow from or are produced by well 12.

It is also contemplated that invention 10 may be utilized with a plurality of wells or other facilities and that well 12 as generally depicted and described is for purposes of illustration of a preferred embodiment. The term well 12 may be generalized to mean all sources or structures of product 20. Furthermore, it is contemplated that invention 10 may be utilized for other well applications other than hydrocarbon retrieval. It is contemplated that invention 10 may be used for other applications where storage and separation under pressure may be desirable such as in chemical plant operations, food production operations and so forth.

Top 16 of well 12 may be wellhead assembly 22 for a plunger lift system as generally depicted and described. It is understood that other well 12 configurations may be utilized and that the illustrations and depiction are for a preferred embodiment and should not be considered limited to such. Furthermore, it is contemplated that invention 10 may be utilized in well 12 where sufficient bottom hole pressure obviates the need for a plunger. As generally depicted, product 20 flows from well 12 via production flow line 24.

In a preferred construction, invention 10 may generally include vessel 26 that is constructed to hold pressure therein. Vessel 26 generally comprises an exterior 28, an interior 30, a production or product 20 inlet 32, a lower fluid outlet 34, a sales line 36, a pressure safety release assembly 38, and an access port 40. Furthermore, vessel 26 may include a support structure 42, an interior 30 pressure gauge 44, a fluid 46 level indicator 48, and agitator 50.

In a preferred embodiment, vessel 26 may be constructed from a converted trailer tanker 52 such as typically associated with the trucking industry wherein the trailer portion containing a pressure vessel may be utilized. As such, tanker 52 may have its wheels removed and necessary elements converted. It is understood that the conversion of existing tanker 52 is not considered to be limiting. Other existing vessels may be converted, such as but not limited to railroad type tankers, or other vessels known in the transportation field. It is also understood that it may be desirable to utilize these existing types of transportation vessels wherein the mode of transportation, such as the wheels for roadways and/or wheels for railroad tracks, may be retained to allow vessel 26 to be relatively mobile in nature.

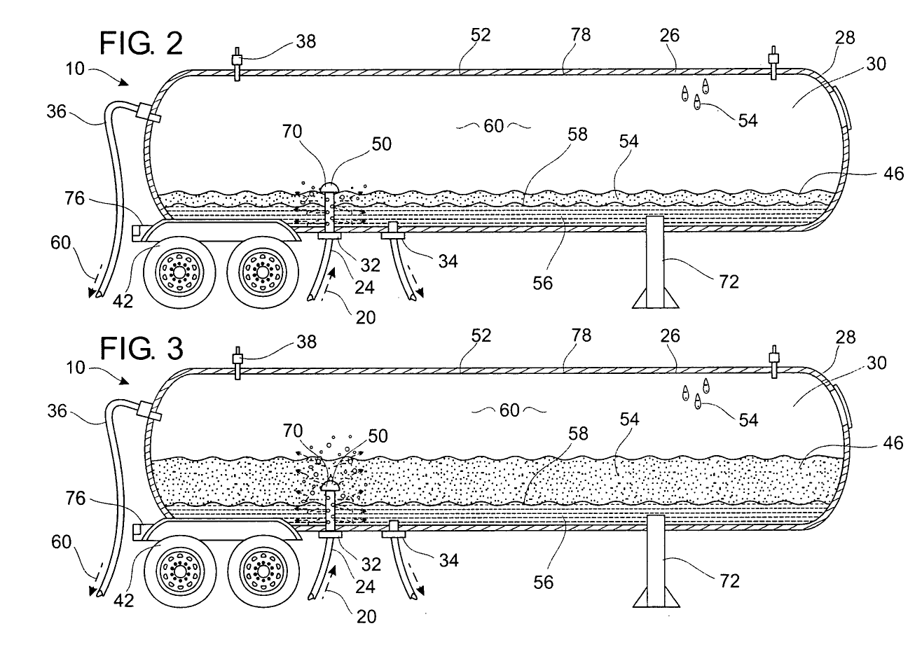

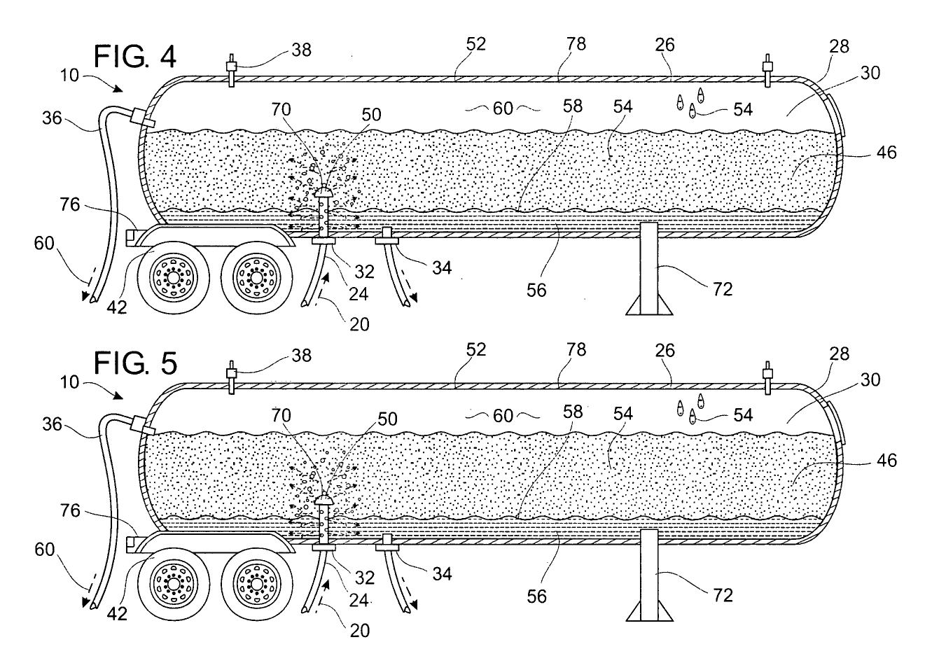

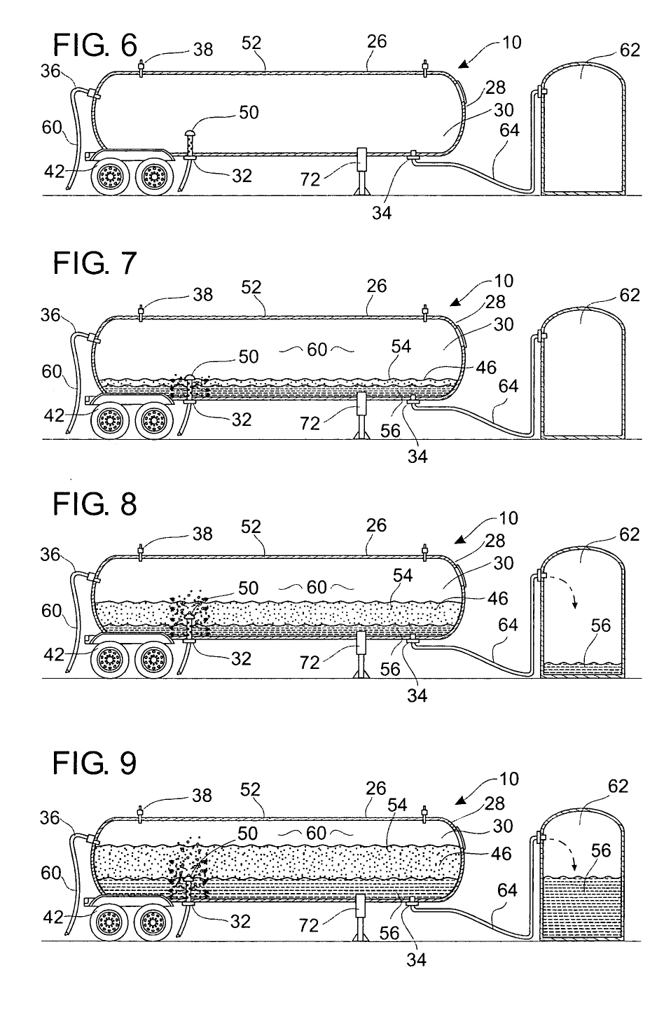

Referring now further to FIG. 1 and FIGS. 2-9, vessel 26 may be of different sizes and configuration and should not be considered to be limited by the illustrations and examples. In a preferred embodiment, vessel 26 may have at least 10,000 gallon capacity or 238 BBL. Salvaged equipment as described above may include pressure testing, altering existing configuration to accept various drains, gauges, intake connections and other parts in accordance with the present invention. Vessel 26 may be of various bursting strength or pressure testing. In a preferred embodiment, bursting strength may be 500 psi. It is understood that greater or lesser amounts may be utilized. Likewise, vessel 26 may be of 60,000 gallon capacity and different configuration and wherein conduits, lines, valves, and so forth may be of varying size such as but not limited ½ inch line and 8 inch line. It is understood that various sizes and configurations are contemplated and that the foregoing are examples and not to be considered limitations.

Vessel 26 access port 40 may be a manhole type configuration to allow an operator or equipment into interior 30. When prior equipment is utilized or in general, access port 40 should be of a nature to hold pressure. Further as a safety precaution or to generally act as a pressure relief for moving, accessing, and so forth, vessel 26, pressure safety release assembly 38 may be provided wherein at a given pressure, a valve would open to allow venting of interior 30. The pressure safety release assembly 38 may be set at a given pressure to open or further include a variable adjustment means for selectively altering the pressure value for opening. Likewise, interior 30 pressure gauge 44 may further include a control means to work in cooperation with pressure safety release assembly 38.

Of note, it is understood that fluid 46 may be comprised of differing elements such as condensate 54, saltwater or water 56, crude oil or oil 58. It is understood that typically water 56 will sink to a lower level than condensate 54 or oil 58 and thus allowing for a relative separation through gravity wherein the water 56 may be drained out of lower fluid 46 outlet 34 which may be relatively positioned at the bottom or lower portion or area of interior 30 of vessel 26.

Furthermore, fluid 46 that may contain hydrocarbons such as condensate 54 and or oil 58 may then be retrieved out of vessel 26 after water 56 is first removed. This may be accomplished through lower fluid 46 outlet 34 or a separate outlet (not depicted). It is contemplated that water 56 may be passed into a container 62 for storage and that a conduit 64 may be dedicated to such from vessel 26. It is also contemplated that condensate 54 and or oil 58 may also be stored in a stock tank container 66 (not depicted) and that a conduit 68 (not depicted) may be dedicated to such from vessel 26. Both containers 62 and 66 may be a separate pressure capable vessel 26. It is understood that invention 10 may utilize numerous or a plurality of vessel 26.

Fluid 46 level indicator 48 may be of numerous configuration such as but not limited to a site tube, gauge, or other known means for determining the amount of fluid 46 accumulation in vessel 26. It is contemplated that sensors (not depicted) may be utilized to notice an operator when water 56 may need to be removed, condensate 54 and or oil 58 is in sufficient quantity for an action of removal from the vessel 26. It is also contemplated that other sensors may be utilized for communicating with an operator in regards to pressure amount.

Likewise, natural gas or gas 60 will generally rise and separate in interior 30 of vessel 26. Sales line 36 may be utilized to allow gas 60 to flow from vessel 26 into a separate facility (not depicted). Sales line 36 may also be utilized for other elements other than gas 60 depending on the production from well 12.

In accordance with a preferred embodiment of the invention, agitator 50 may be utilized to further enhance the separation of elements or product 20. As product 20 enters the vessel 26, it is contemplated that a spray type nozzle 70 may be used such that product 20 is forced into a spray wherein separation of elements may be achieved more efficiently. It is understood that a preferred embodiment of invention 10 may not include agitator 50 or that another configuration may be utilized to enhance separation as currently known in the industry. Furthermore, it is contemplated that the spraying, mixing, separating, and agitating of fluid 46 will further increase the BTU rating and therefore increase the value of the gas.

In another preferred embodiment, support structure 42 may include a jack 72 which may raise or lower vessel 26. Jack 72 may be hydraulic but is not limited to such and may be used to facilitate the removal of fluid 46 wherein water 56 is removed at a lower point. Further, oil 58 and condensate 54 may also utilize the lowering feature.

Support structure 42 may further include a wheel assembly 76 as commonly found on an existing tanker 52. It is contemplated that tanker 52 may be of numerous configurations and sizes, retain its mobile nature for transporting from well 12 to other wells. Further, it is understood that although the drawings may not depict the hitch mechanisms commonly associated with tankers 52, they may be utilized for transporting via truck, tractor and so forth or removed if desired.

In another preferred embodiment, invention 10 may further provide a mobile system 78 for utilization of monitoring, testing, collecting, and/or separating production from an individual well 12 that may be part of a common collection production system from multiple wells in a field.

### In Operation

In a preferred method of operation, invention 10 may include connecting vessel 26 with well 12 wherein product 20 from well 12 operation moves through production flow line 24 into vessel 26 through inlet 32. It is understood that invention 10 should generally be a closed system where all material, air, things, fluid and so forth from well 12 are contained and move into vessel 26. It is further contemplated that invention 10 may be a partially open system and that a preferred construction is a complete or nearly completely closed system trapping all elements produced from well 12 operations.

Product 20 flows into the interior 30 of vessel 26 and passes through agitator 50. Agitator 50 disperses product 20 and separates the differing elements. As such, water 56 will collect at the bottom of vessel 26 and condensate 54 and oil 58 will generally stay on top of water 56. Gas 60 will pass through sales line 36.

At a desired amount or time, water 56 may be removed through lower fluid outlet 34 leaving condensate 54 and oil 58 to be collected for sale. Water 56 may be treated on site or removed to a secure location or container 62.

It is further contemplated that well 12 function may be regulated with a pressure clock 74 working in conjunction with vessel 26. Pressure clock 74 would allow pressure to fill in the vessel 26 and still allow well 12 operations.

Changes may be made in the combinations, operations, and arrangements of the various parts and elements described herein without departing from the spirit and scope of the invention. In a preferred embodiment, a pressure storage vessel with separation system may comprise a vessel capable of holding pressure having an interior; an access port for allowing a human into the interior of the vessel; a pressure relief valve that allows pressure to vent from the interior of the vessel; a production line inlet that allows production from a well to enter the interior of the vessel tanker; an agitator in the interior of the vessel wherein the agitator is connected to the production line inlet; a first outlet to let accumulated gas selectively flow from the vessel interior to a collection point; a second outlet to let accumulated fluid be selectively drained from the vessel; and a wheel assembly attached to the vessel for transporting the vessel. Further, the vessel may be a trailer tanker with wheels, further include a pressure gauge for determining the pressure in the trailer tanker, and a liquid level indicator for indicating the level of liquid in the vessel interior.

In a preferred embodiment of the invention, a method of converting a trailer tanker to a mobile pressure storage vessel with separation apparatus may comprise the steps of providing a trailer tanker having an interior, an exterior, and wheels; making an access port for a human to enter the trailer tanker; installing a pressure relief valve that allows pressure to vent from the interior of the trailer tanker; installing a production line inlet that allows production from a well to enter the interior of the trailer tanker; installing an agitator in the interior of the trailer tanker that connects to the production line inlet; installing a first outlet to let accumulated gas selectively flow from the interior of the trailer tanker to a collection point; and installing a second outlet to let accumulated fluid be selectively drained from the interior of the trailer tanker.

### EXAMPLE 1

A small producing gas well 12 in Caddo County, Oklahoma was chosen for the experiment. The well 12 was connected to a low-pressure gas gathering system that provided natural gas to nearby homes and to peanut farmers in the area for heaters to dry the peanuts after being dug up and sorted. The gathering and distribution lines were made of PVC pipe with a bursting strength of 125 psi., and therefore the well 12 was not allowed to produce into the line at pressures above 65 psi. The invention 10 was therefore closely regulated and at times, somewhat restricted in productive capacity. The invention 10 performed very well until the bottom hole pressure depleted to the point that it could no longer run the plunger lift system, and the well 12 was then plugged and abandoned.

### EXAMPLE 2

In another experiment, invention 10 was moved to another well 12 in Canadian County, Oklahoma. The well 12 had been purchased from the previous operator who had shut it in previously and was preparing to plug and abandon it as an uneconomical venture. Later, another operator re-established production and worked over the same producing intervals, including the installation of a plunger lift system. The well 12 produced volumes at a slightly higher rate than during the last few months before being shut in.

After replacing the worn plungers again, invention 10 was installed. The well 12 increased the gas and condensate volumes to a level above the original flowing rates when the well 12 was new and to rates seven times as high as the levels in previous years. To date, the well 12 has produced almost as much new natural gas as it did in its original 8.5 year life. Condensate is being saved under pressure and sold as volumes permit.

1. A pressure storage vessel with separation system comprising:
a vessel capable of holding pressure having an interior;
an access port for allowing a human into said interior of said vessel;
a pressure relief valve that allows pressure to vent from said interior of said vessel;
a production line inlet that allows production from a well to enter said interior of said vessel tanker;
an agitator in said interior of said vessel wherein said agitator is connected to said production line inlet;
a first outlet to let accumulated gas selectively flow from said vessel interior to a collection point;
a second outlet to let accumulated fluid be selectively drained from said vessel; and
a wheel assembly attached to said vessel for transporting said vessel.

2. The invention of claim 1 wherein said vessel is a trailer tanker with wheels.

3. The invention of claim 2 further including a pressure gauge for determining the pressure in said trailer tanker.

4. The invention of claim 3 including a liquid level indicator for indicating the level of liquid in said vessel interior.

5. A method of converting a trailer tanker to a mobile pressure storage vessel with separation apparatus comprising the steps of:
providing a trailer tanker having an interior, an exterior, and wheels;
making an access port for a human to enter said trailer tanker;
installing a pressure relief valve that allows pressure to vent from said interior of said trailer tanker;
installing a production line inlet that allows production from a well to enter said interior of said trailer tanker;
installing an agitator in said interior of said trailer tanker that connects to said production line inlet;
installing a first outlet to let accumulated gas selectively flow from said interior of said trailer tanker to a collection point; and
installing a second outlet to let accumulated fluid be selectively drained from said interior of said trailer tanker.
